(19) United States
(12) Patent Application Publication
(10) Pub. No.: US 2026/0356133 A1
(43) Pub. Date: Nov. 12, 2026

(54) RUN-FLAT TIRE

(71) Applicant: ZHIQING YE, Guangdong (CN)

(72) Inventor: ZHIQING YE, Guangdong (CN)

(21) Appl. No.: 19/289,088

(22) Filed: Aug. 3, 2025

(30) Foreign Application Priority Data
May 12, 2025 (CN) 202520928782.9

(51) Int. Cl. B60C 17/01; B60C 5/20

(52) U.S. Cl. CPC B60C 17/01; B60C 5/20

(57) ABSTRACT

A run-flat tire includes a tire body with an inner cavity, a valve component and a plurality of inflation tubes located inside the tire body. The inner cavity is divided into several chambers, each of which is connected to one end of each of the inflation tubes. The valve component is connected to the tire body and exposed on an inner side of the tire body. The valve component is equipped with a plurality of cores, each of which is connected to the other end of each of the inflation tubes.

### CROSS-REFERENCE TO RELATED APPLICATION

This application claims the priority benefit of China application serial no. 202520928782.9, filed on May 12, 2025. The entirety of the above-mentioned patent application is hereby incorporated by reference herein and made a part of this specification.

### BACKGROUND

### Technical Field

The present invention relates to a field of tire technology, specifically involving a run-flat tire.

### Description of Related Art

Tires are circular, elastic rubber products that are mounted on various vehicles or machinery for ground contact and rolling. They are usually installed on metal rims, capable of supporting the vehicle body, cushioning external impacts, ensuring contact with the road surface and guaranteeing the vehicle's driving performance. Tires typically have an inner cavity for holding air, which is inflated to reduce the tire's weight and enhance comfort during use. However, if a tire is damaged, it will leak air, affecting the normal operation of the vehicle. In more severe cases, it may lead to a blowout, causing traffic accidents and significantly compromising the safety of passengers.

In prior arts, a Chinese patent with a publication number of CN2328538Y discloses a run-flat tire that is resistant to aging and has a long service life. The tire is divided into several independent air chambers, each equipped with an inflation valve and a run-flat threshold valve. When one air chamber leaks, the remaining chambers remain intact, allowing the driver more time to maintain vehicle control and avoid a severe blowout accident. However, due to the independent inflation valves on each air chamber, inflating the tire is quite inconvenient.

A Chinese patent with a publication number of CN201056139Y discloses a new run-flat tire, which is divided into several air chambers. Each air chamber is connected with others by annular ventilation tubes which are connected to an inflation core. By using annular ventilation tubes to connect each air chamber, the patent solves the problem of inconvenient tire inflation found in the CN2328538Y Chinese patent to a certain extent, however, due to the fact that all air chambers are interconnected and if one air chamber leaks, the others will also leak, making it difficult to buy more time for the driver.

### SUMMARY

To overcome the problem of inconvenient inflation in run-flat tires with multiple independent air chambers as found in prior arts, the present invention provides a run-flat tire which not only has a good run-flat effect but also is convenient for inflation.

To solve the above-mentioned problem, a technical solution adopted by the present invention is as follows: a run-flat tire, which includes a tire body with an inner cavity, a valve component and a plurality of inflation tubes located inside the tire body. The inner cavity is divided into several chambers, each of which is connected to one end of each of the inflation tubes. The valve component is connected to the tire body and exposed on an inner side of the tire body. The valve component is equipped with a plurality of cores, each of which is connected to the other end of each of the inflation tubes.

In the technical solution of the present invention, the tire body is divided into several independent chambers, and if one of the chambers leaks, the other chambers can still function normally, thus avoiding serious blowout accidents. Since the tire body is equipped with the valve component which is equipped with the cores, and each of the cores is connected to each of the chambers, it is capable to inflate all the chambers at the same time while ensuring the independence among all the chambers, making the inflation process more convenient. As all the chambers are inflated through the valve component at the same time, air pressure in each chamber is consistent, ensuring the performance of the run-flat tire.

Further, the valve component also includes an outer sleeve. The interior of the outer sleeve has an inflation chamber and a plurality of installation slots that run through radially. Each of the cores is connected to each of the installation slots. One end of each of the installation slots is connected to each of the inflation tubes, while the other end of each of the installation slots is connected to the inflation chamber.

In this solution, the outer sleeve is configured to integrate the cores. The inflation chamber can be connected to an external air source device to facilitate simultaneous inflation of all cores.

Further, the cores are equipped with external threads, and the installation slots are equipped with internal threads. The cores are connected to the installation slots by thread.

In this solution, the cores are connected by thread which makes it easy to replace the cores.

Further, the valve component also includes a pressing plate which is detachably connected to the outer sleeve. The pressing plate is configured to contact with the cores to open them all at the same time, and to be separated from the cores to close them.

In this solution, the pressing plate is configured to contact the cores simultaneously, allowing the latter to open at the same time for simultaneous inflation.

Further, the valve component also includes a cap, which is detachably connected to the outer sleeve.

In this solution, the cap connected to the outer sleeve can provide protection.

Further, the pressing plate is fixedly connected to an inner side of the cap. The cap is connected to the outer sleeve by thread to bring the pressing plate closer to or further away from each of the cores. The cap is equipped with an inflation port which is fluidly connected to the inflation chamber.

In this solution, by connecting the pressing plate in the inner side of the cap, when the cap is tightened by thread, the pressing plate can move towards the cores to open the cores. The inflation port equipped with the cap can be connected to the external air source device for inflation.

Further, the pressing plate is configured as a ring structure. Each of the cores is set at the same height in the outer sleeve. The pressing plate corresponds to each of the cores in a vertical direction.

In this solution, the ring-structure pressing plate can conveniently connect with each of the cores and does not affect gas passing through the ring structure during inflation.

Further, the inner cavity is divided into several chambers along a circumferential and/or a radial direction.

In this solution, by dividing along the circumferential and/or radial direction, the several chambers are formed to enhance the run-flat effect of the tire.

Further, the run-flat tire also includes an exhaust component, including an exhaust tube, an exhaust fitting, a block and an exhaust cap. Each of the chambers is independently connected to the exhaust tube, the exhaust tube is connected to the exhaust fitting, the block is in contact with an outlet of the exhaust tube, and the exhaust cap is detachably connected to the exhaust fitting to press the block.

In this solution, when it is necessary to disassemble and repair the run-flat tire, simply opening the exhaust cap and taking the block off allow the air in each of the chambers to be discharged through the exhaust tube with high exhaust efficiency.

Further, the exhaust fitting is equipped with a plurality of exhaust holes. One end of the exhaust holes is connected to the exhaust tube and the other end of the same are in contact with the block.

In this solution, by connecting the exhaust holes and the exhaust tube, it is easy to facilitate sealing with using the block.

Further, the cores include a core seat, a core body and an elastic element. The core seat is equipped with a through air passage inside. In the air passage, a first shoulder and a second shoulder are set. The core body is set through the air passage and has a first protrusion and a second protrusion extending radially. The elastic element is set inside the air passage and is connected to or in contact with both the core seat and the core body. The first shoulder and the second shoulder are in contact with the first protrusion and the second protrusion, respectively, to block the air passage.

In this solution, the core body is blocked in the core seat by the elastic element. When inflation is needed, pressing the core body to push the elastic element can open the air passage, which is convenient for sealing and inflation.

Further, the tire body is configured as an inner side and an outer side, where the hardness of the inner side of the tire body is 15%-20% lower than that of the outer side.

In this solution, the difference in hardness between the inner side and the outer side of the tire body can improves the durability of the tire body and comfort of driving.

Compared with prior art, the beneficial effects of the present invention are as follows:

The run-flat tire, according to the present invention, divides the tire body into several independent chambers. When one chamber leaks, the other chambers can still function normally, thus avoiding serious blowout accidents. Since the tire body is equipped with a valve component, which has several cores and each of which connected to each chamber via an inflation tube, it is capable to inflate all the chambers simultaneously while ensuring all the chambers to be independent, making the inflation process more convenient. As all the chambers are inflated through the valve component at the same time, air pressure in each chamber is consistent, ensuring the performance of the run-flat tire.

### BRIEF DESCRIPTION OF THE DRAWINGS

FIG. 1 is a sectional view of a radial cross-section of the run-flat tire according to the present invention;

FIG. 2 is a sectional view of an axial cross-section of the run-flat tire according to the present invention;

FIG. 3 is a structural diagram of the valve component from a top view perspective;

FIG. 4 is a sectional view of the FIG. 3 along A-A section;

FIG. 5 is a sectional view of the core in the FIG. 4;

FIG. 6 is a sectional view of a radial cross-section of the run-flat tire according to some embodiments of the present invention;

FIG. 7 is a structural diagram of the exhaust component from a top view perspective with the block and the exhaust cap removed;

FIG. 8 is a sectional view of the exhaust component along B-B section in the FIG. 7.

### DESCRIPTION OF THE EMBODIMENTS

The accompanying drawings are merely illustrative and should not be construed as limiting this patent. To better illustrate embodiments, some components in the drawings may be omitted, enlarged, or reduced in size, which does not represent the actual dimensions of the product. It is understandable that certain well-known structures and their descriptions may be omitted in the drawings for those skilled in the art. The positional relationships described in the drawings are for illustrative purposes only and should not be construed as limiting this patent.

In the drawings of the embodiments of the present invention, the same or similar reference numerals correspond to the same or similar components. In the description of the present invention, it should be understood that terms such as “upper,” “lower,” “left,” “right,” “long,” “short,” etc., which indicate directions or positional relationships, are based on the directions or positional relationships shown in the drawings. These terms are used merely for the convenience of describing the present invention and simplifying the description, rather than indicating or implying that the device or element must have a specific orientation, be constructed and operated in a specific orientation. Therefore, the terms used to describe positional relationships in the drawings are for illustrative purposes only and should not be construed as limiting the present invention. For those skilled in the art, the specific meanings of the above terms can be understood according to specific situations.

The technical solution of the present invention will be further specifically described below through specific embodiments and in combination with accompanying drawings.

### Embodiment 1

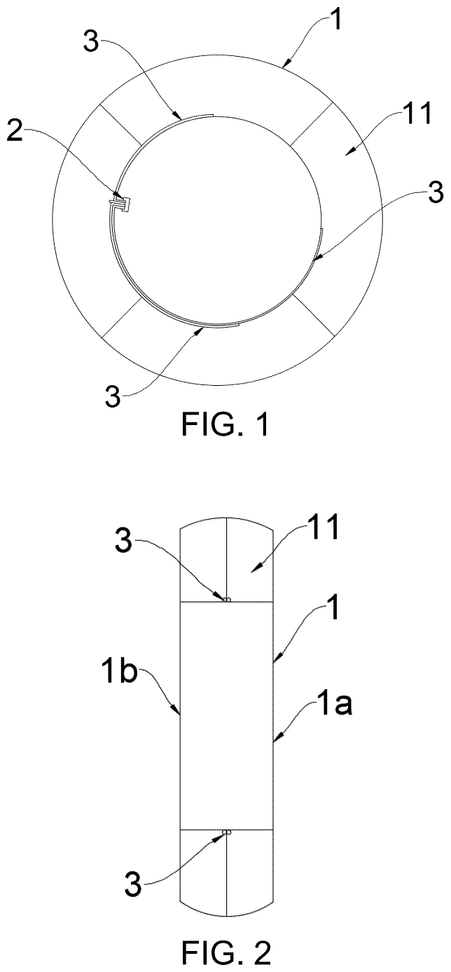

Referring to FIGS. 1 to 3, this embodiment discloses a run-flat tire, which includes a tire body 1 with an inner cavity, a valve component 2 and a plurality of inflation tubes 3 located inside the tire body 1. The inner cavity is divided into several chambers 11, each of which is connected to one end of each of the inflation tube 3. The valve component 2 is connected to the tire body 1 and exposed on an inner side of the tire body 1. The valve component 2 is equipped with a plurality of cores 21, each of which is connected to the other end of each of the inflation tube 3.

In this embodiment, the tire body 1 is divided into several independent chambers 11, and if one of the chambers 11 leaks, the other chambers 11 can still function normally, thus avoiding serious blowout accidents. Since the tire body 1 is equipped with the valve component 2 which is equipped with the cores 21, and each of the cores 21 is connected to each of the chambers 11 via the inflation tubes 3, it is capable to inflate all the chambers 11 at the same time while ensuring the independence among all the chambers 11, making the inflation process more convenient. As all the chambers 11 are inflated through the valve component 2 at the same time, comparing with inflating each chamber 11 separately, this embodiment achieves that the air pressure in each chamber 11 is consistent, ensuring the performance of the run-flat tire. The inflation tubes 3 can be fixed to the inner side wall of the tire body 1 to prevent the inflation tube 3 from swinging of falling off during use.

It can be understood that each of the chambers 11 is connected by an independent inflation tube 3, and some of the inflation tubes 3 may pass through adjacent other chamber 11 to reach the corresponding chamber 11. For such a situation, the inflation tube 3 is still sealed with the other chamber 11 it passes through and is only connected to the corresponding chamber 11.

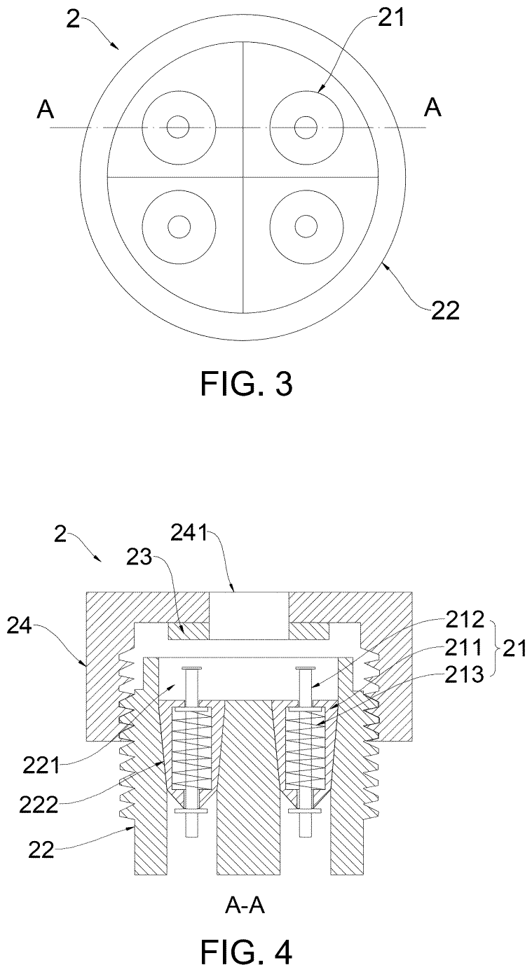

Referring to FIGS. 3 and 4, in this embodiment, the valve component 2 also includes an outer sleeve 22. The interior of the outer sleeve 22 has an inflation chamber 221 and a plurality of installation slots 222 that run through radially. Each of the cores 21 is connected to each of the installation slots 222. One end of each of the installation slots 222 is connected to each of the inflation tubes 3, while the other end of each of the installation slots 222 is connected to the inflation chamber 221.

Specifically, tanking the direction shown in the figures as an example, the outer sleeve 22 can be in a shape of a substantially cylindrical tube. The inflation chamber 221 is provided at the upper end of the outer sleeve 22. In an uninflated state, the inflation chamber 221 is open upwards, and the core 21 is closed, thus there is no air leakage. When inflating, an external air source device is connected to the inflation chamber 221 and each core 21 is opened simultaneously for inflation. The inflation chamber 221 is configured to connect an upper inlet of the core 21, therefore inflation can be performed at a same pressure, improving the efficiency of inflation and ensuring a balanced air pressure in each chamber 11, which is beneficial for the use of the run-flat tire. In this embodiment, the outer sleeve 22 is configured to integrate the cores 21. The inflation chamber 221 can be connected to the external air source device to facilitate simultaneous inflation of all cores 21.

In this embodiment, the cores 21 are equipped with external threads, and the installation slots 222 are equipped with internal threads. The cores 21 are connected to the installation slots 222 by thread. The cores 21, by detachably connecting to the installation slots 222, is convenient to be replaced. The threads of the cores 21 and of the installation slots 222 are not shown in the figures.

Referring to FIG. 4, the valve component 2 also includes a pressing plate 23 which is detachably connected to the outer sleeve 22. The pressing plate 23 is configured to contact with the cores 21 to open them all at the same time, and to be separated from the cores 21 to close them. The pressing plate 23 is configured to contact the cores 21 simultaneously, allowing the latter to open at the same time for simultaneous inflation.

In some embodiments, the pressing plate 23 can be removed and connected to an air outlet of the external air source device. In this way, when the external air source device is connected to the valve component 2 performing inflation, the pressing plate 23 is in contact with the cores 21 to open them, allowing simultaneous inflation of the cores 21 and simultaneous inflation of the chambers 11 of the run-flat tire. Obviously, the pressing plate 23 will not block the air outlet of the external air source device, by using a ring-shaped pressing plate 23 or by making a hole in the pressing plate 23.

Referring to FIG. 4, the valve component 2 also includes a cap 24. The cap 24 is detachably connected to the outer sleeve 22 to provide protection by connecting the cap 24 to the outer sleeve 22. In some embodiments, a top of the cap 24 can be closed, therefore the cores 21 can be protected by the cap 24. When inflation is needed, the cap 24 can be removed for inflation.

Referring to FIGS. 1 and 2, the inner cavity is divided into several chambers 11 along a circumferential and/or a radial direction. For example, the inner cavity of the tire can be divided into four, or other numbers of, chambers 11 along the circumferential direction. For those larger tires, the inner cavity can be divided into two parts along the radial direction, and then each part can be divided into four chambers 11 along the circumferential direction, for example a total of eight chambers 11, to improve the run-flat performance. The number of the cores 21 corresponds to the number of the chambers 11, for example, eight chambers 11 are equipped with eight cores 21. The chambers 11 can be separated by separators, which can be made of the same rubber material as the tire, or can be made by other materials used to make tire, which are soft, elastic and not easy to break. The inflation tubes 3 pass through the separators to connect with corresponding chambers 11, and the inflation tubes 3 are sealed with the separators.

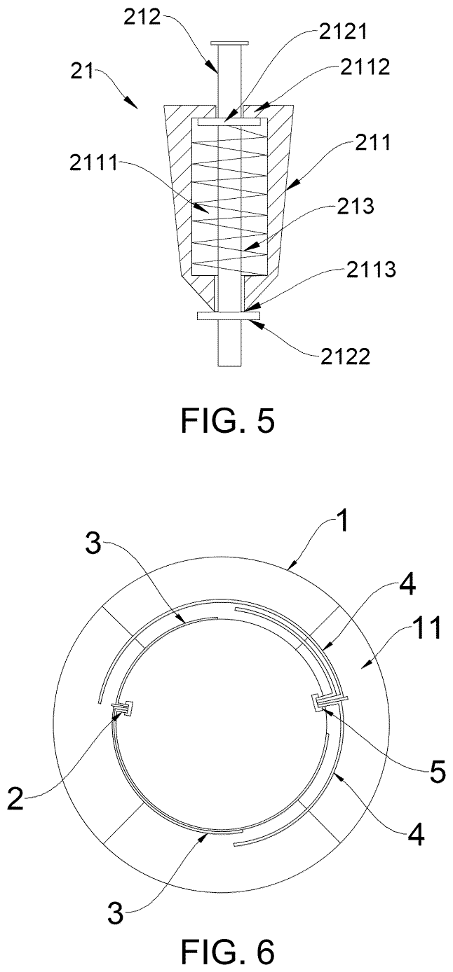

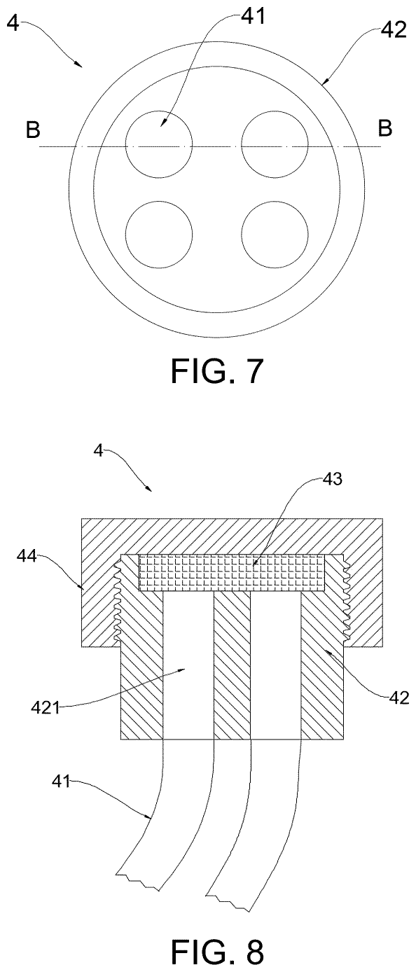

Referring to FIG. 5, the cores 21 include a core seat 211, a core body 212 and an elastic element 213. The core seat 211 is equipped with a through air passage 2111 inside. In the air passage 2111, a first shoulder 2112 and a second shoulder 2113 are set. The core body 212 is set through the air passage 211 and has a first protrusion 2121 and a second protrusion 2122 extending radially. The elastic element 213 is set inside the air passage 2111 and is connected to or in contact with both the core seat 211 and the core body 212. The first protrusion 2121 and the second protrusion 2122 are in contact with the first shoulder 2112 and the second shoulder 2113, respectively, to block the air passage 2111. The core body 212 is blocked in the core seat 211 by the elastic element 213. When inflation is needed, pressing the core body 212 to push the elastic element 213 can open the air passage 2111, which is convenient for sealing and inflation.

Specifically, the elastic element 213 is a compression spring. Taking the direction shown in the figures as an example, an upper end of the compression spring is in contact with a lower end of the first protrusion 2121 of the core body 212, while a lower end of the compression spring is in contact with a lower end of the air passage 2111. Under no external force, the compression spring pushes the core body 212 upwards to contact the core seat 211, thereby blocking the air passage 2111, and the cores 21 are closed. When the core body 212 is subjected to downward pressure, the compression spring is compressed downwards. The first protrusion 2121 and the second protrusion 2122 are separated from contacting with the first shoulder 2112 and the second shoulder 2113. At this time, the cores 21 are opened, and each of the chambers 11 can be inflated by an external high-pressure air source device.

Referring to FIG. 2, in this embodiment, the tire body 1 is configured as an inner side 1a and an outer side 1b, where the hardness of the inner side 1a of the tire body is 15%-20% lower than that of the outer side 1b. The difference in hardness between two sides of the tire body 1 can improves the durability of the tire body and comfort of driving. The inner side 1a is a side closer to a central axis of a vehicle when the body tire 1 is installed on the vehicle, while the outer side 1b is a side farther from the central axis of the vehicle when the body tire 1 is installed on the vehicle.

### Embodiment 2

Referring to FIG. 4, this embodiment is similar to Embodiment 1, with difference being that in this embodiment, the pressing plate 23 is fixedly connected to an inner side of the cap 24. The cap 24 is connected to the outer sleeve 22 by thread to bring the pressing plate 23 closer to or further away from each of the cores 21. The cap 24 is equipped with an inflation port 241 which is fluidly connected to the inflation chamber 221. By connecting the pressing plate 23 in the inner side of the cap 24, when the cap 24 is tightened by thread, the pressing plate 23 can move towards the cores 21 to open the cores. The inflation port 241 equipped with the cap 24 can be connected to the external air source device for inflation. When there is no requirement of inflation, the cap 24 can be replaced with one without the inflation port 241, and there is no pressing plate 23 setting inside the cap 24. In other words, the cap 24 with the pressing plate 23 and the inflation port 241 is designed for convenient inflation, and after inflation is completed, a regular cap 24 can be replaced with.

Referring to FIG. 4, in this embodiment, the pressing plate 23 is configured as a ring structure. Each of the cores 21 is set at the same height in the outer sleeve 22. The pressing plate 23 corresponds to each of the cores 21 in a vertical direction. The ring-structure pressing plate 23 can conveniently connect with each of the cores 21 and does not affect gas passing through the ring structure during inflation.

Referring to FIG. 4, in this embodiment, the cap 24 is equipped with internal threads, the outer sleeve 22 is equipped with external threads, and the cap 24 is connected to the outer sleeve 22 by thread. In some embodiments, the cap 24 is equipped with external threads, and an inner part, located above the cores, of the outer sleeve 22 is equipped with internal threads. The cap 24 is connected to an inner side of the outer sleeve 22 by thread. It should be clear that though the dimensions of the cap 24 may be different, all can achieve a function that the pressing plate 23 moves towards the cores 21 to open each of the cores 21 when the cap 24 is threadedly connected to the outer sleeve 22.

### Embodiment 3

Referring to FIG. 6, this embodiment is similar to Embodiment 1, with difference being that in this embodiment, an exhaust component 4 is included. The exhaust component 4 includes an exhaust tube 41, an exhaust fitting 42, a block 43 and an exhaust cap 44. Each of the chambers 11 is independently connected to the exhaust tube 41, the exhaust tube 41 is connected to the exhaust fitting 42, the block 43 is in contact with an outlet of the exhaust tube 41, and the exhaust cap 44 is detachably connected to the exhaust fitting 42 to press the block 43.

It can be understood that since the exhaust tube 41 is independently connected to each of the chambers 11, the chambers 11 are not connected to each other through the exhaust tube 41. Even if one of the chambers 11 leaks, it will not cause others to leak through the exhaust tube 41. When it is necessary to disassemble and repair the run-flat tire, simply opening the exhaust cap 44 and taking the block 43 off allow the air in each of the chambers 11 to be discharged through the exhaust tube 41 with high exhaust efficiency. The block 43 is preferred to be made as a rubber block to provide good airtightness. In some embodiments, providing an exhaust valve for each exhaust tube 41 can also achieve a function of exhausting of each of the chambers 11.

In this embodiment, the exhaust fitting 42 is equipped with a plurality of exhaust holes 421. One end of the exhaust holes 421 are connected to the exhaust tube 41 and the other end of the same are in contact with the block 43. By connecting the exhaust holes 421 and the exhaust tube 41, it is easy to facilitate sealing with using the block 43.

The above embodiments of the present invention are merely examples provided to clearly illustrate the invention and do not limit the implementation methods of the invention. Ordinary technicians in the field can make other changes or modifications based on the above description. It is neither necessary nor possible to exhaustively list all the implementation methods here. Any modifications, equivalent substitutions, and improvements made within the spirit and principles of the present invention should be included within the scope of protection of the claims of the present invention.

What is claimed is:

1. A run-flat tire, comprising a tire body with an inner cavity, a valve component and a plurality of inflation tubes located inside the tire body, wherein the inner cavity is divided into several chambers, each of which is connected to one end of each of the inflation tubes, the valve component is connected to the tire body and exposed on an inner side of the tire body, and the valve component is equipped with a plurality of cores, each of which is connected to the other end of each of the inflation tubes.

2. The run-flat tire according to claim 1, wherein the valve component comprises an outer sleeve, an interior of the outer sleeve has an inflation chamber and a plurality of installation slots that run through radially, each of the cores is connected to each of the installation slots, and one end of each of the installation slots is connected to each of the inflation tubes, while the other end of each of the installation slots is connected to the inflation chamber.

3. The run-flat tire according to claim 2, wherein the cores are equipped with external threads, the installation slots are equipped with internal threads, and the cores are connected to the installation slots by thread.

4. The run-flat tire according to claim 2, wherein the valve component further comprises a pressing plate which is detachably connected to the outer sleeve, and the pressing plate is configured to contact with the cores to open the cores all at the same time, and to be separated from the cores to close the cores.

5. The run-flat tire according to claim 4, wherein the valve component further comprises a cap, which is detachably connected to the outer sleeve.

6. The run-flat tire according to claim 5, wherein the pressing plate is fixedly connected to an inner side of the cap, the cap is connected to the outer sleeve by thread to bring the pressing plate closer to or further away from each of the cores, and the cap is equipped with an inflation port which is fluidly connected to the inflation chamber.

7. The run-flat tire according to claim 6, wherein the pressing plate is configured as a ring structure, each of the cores is set at a same height in the outer sleeve, and the pressing plate corresponds to each of the cores in a vertical direction.

8. The run-flat tire according to claim 1, wherein the inner cavity is divided into several chambers along a circumferential and/or a radial direction.

9. The run-flat tire according to claim 1, wherein the run-flat tire further comprises an exhaust component, including an exhaust tube, an exhaust fitting, a block and an exhaust cap, and each of the chambers is independently connected to the exhaust tube, the exhaust tube is connected to the exhaust fitting, the block is in contact with an outlet of the exhaust tube, and the exhaust cap is detachably connected to the exhaust fitting to press the block.

10. The run-flat tire according to claim 9, wherein the exhaust fitting is equipped with a plurality of exhaust holes, and one end of the exhaust holes are connected to the exhaust tube and the other end of the same are in contact with the block.

11. The run-flat tire according to claim 1, wherein the cores comprise a core seat, a core body and an elastic element, the core seat is equipped with a through air passage inside, a first shoulder and a second shoulder are set in the air passage, the core body is set through the air passage and has a first protrusion and a second protrusion extending radially, the elastic element is set inside the air passage and is connected to or in contact with both the core seat and the core body, and the first shoulder and the second shoulder are in contact with the first protrusion and the second protrusion, respectively, to block the air passage.

12. The run-flat tire according to claim 1, wherein the tire body is configured as an inner side and an outer side, where a hardness of the inner side of the tire body is 15%-20% lower than a hardness of the outer side.
